(19) United States
(12) Patent Application Publication
(10) Pub. No.: US 2026/0056568 A1
(43) Pub. Date: Feb. 26, 2026

(54) REFERENCE VOLTAGE SUPPLY CIRCUIT

(71) Applicant: REALTEK SEMICONDUCTOR CORPORATION, Hsinchu (TW)

(72) Inventors: Wen-Hau Yang, Hsinchu (TW); Chun-Yu Luo, Hsinchu (TW); Yen-Ting Lin, Hsinchu (TW); Kuo-Chun Wu, Hsinchu (TW)

(21) Appl. No.: 19/214,246

(22) Filed: May 21, 2025

(30) Foreign Application Priority Data
Aug. 20, 2024 (TW) 113131357

(51) Int. Cl. G05F 3/16

(52) U.S. Cl. CPC G05F 3/16

(57) ABSTRACT

A reference voltage supply circuit includes a first transistor, a second transistor, a first resistor, and a second resistor. The first transistor is coupled to a high voltage level terminal. The second transistor is coupled to a low voltage level terminal. The first resistor is coupled with the first transistor at a reference node for providing a reference voltage. The second resistor is coupled between the first resistor and the second transistor. The first resistor and the second resistor include variable resistors.

### BACKGROUND OF THE INVENTION

### 1. Field of the Invention

The present disclosure relates to a reference voltage supply circuit, especially to a reference voltage supply circuit that utilizes a circuit design to prevent a reference voltage from being affected by temperature variation.

### 2. Description of Related Art

A typical bandgap voltage reference circuit is composed of multiple transistors. However, if the transistors are fabricated by different processes or if parameters of the transistors vary due to process drift within the same process, the reference voltage generated by the bandgap voltage reference circuit will be affected by temperature variation.

### SUMMARY OF THE INVENTION

In some aspects, an object of the present disclosure is to, but not limited to, provides a reference voltage supply circuit that makes an improvement to the prior art.

An embodiment of a reference voltage supply circuit of the present disclosure includes a first transistor, a second transistor, a first resistor, and a second resistor. The first transistor is coupled to a high voltage level terminal. The second transistor is coupled to a low voltage level terminal. The first resistor is coupled with the first transistor at a reference node for providing a reference voltage. The second resistor is coupled between the first resistor and the second transistor. The first resistor and the second resistor include variable resistors.

Technical features of some embodiments of the present disclosure make an improvement to the prior art. The reference voltage supply circuit adopts variable resistors to adjust a slope of a temperature coefficient voltage with respect to temperature variation, such that the reference voltage supply circuit can maintain a zero temperature coefficient to prevent the reference voltage from being affected by temperature variation.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a reference voltage supply circuit of the present disclosure.

FIG. 2 shows an embodiment of a reference voltage and a temperature of the present disclosure.

FIG. 3 shows an embodiment of a positive temperature coefficient voltage, a negative temperature coefficient voltage, and a temperature of the present disclosure.

FIG. 4 shows an embodiment of a reference voltage supply circuit of the present disclosure.

FIG. 5 shows an embodiment of a reference voltage and a temperature of the present disclosure.

FIG. 6 shows an embodiment of a positive temperature coefficient voltage, a negative temperature coefficient voltage, and a temperature of the present disclosure.

FIG. 7 shows an embodiment of a reference voltage supply circuit of the present disclosure.

FIG. 8 shows an embodiment of a reference voltage and a temperature of the present disclosure.

FIG. 9 shows an embodiment of a positive temperature coefficient voltage, a negative temperature coefficient voltage, and a temperature of the present disclosure.

### DETAILED DESCRIPTION OF THE PREFERRED EMBODIMENTS

To address a problem in the prior art that a reference voltage is affected by temperature variation, the present disclosure provides a reference voltage supply circuit, which will be explained in detail below.

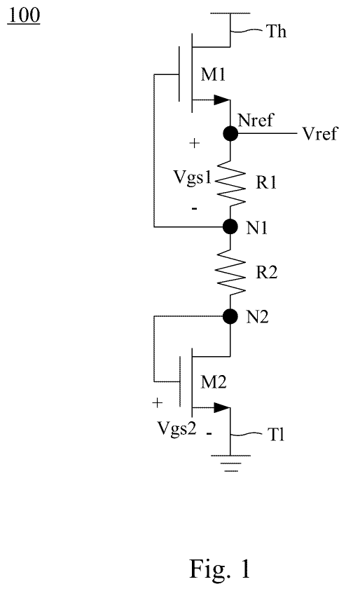

FIG. 1 shows an embodiment of a reference voltage supply circuit 100 of the present disclosure. As shown in the figure, the reference voltage supply circuit 100 includes a first transistor M1, a second transistor M2, a first resistor R1, and a second resistor R2.

With respect to circuit designs, the first transistor M1 is coupled to a high voltage level terminal Th, the second transistor M2 is coupled to a low voltage level terminal Tl. In addition, the first resistor R1 and the first transistor M1 are coupled at a reference node Nref for providing a reference voltage Vref. The second resistor R2 is coupled between the first resistor R1 and the second transistor M2. The first resistor R1 and the second resistor R2 include variable resistors. The formula of the reference voltage Vref provided by the reference voltage supply circuit 100 of the present disclosure is as follows:

$$Vref = Vgs 2 + ( \frac{\vert Vgs 1 \vert}{R 1} ) \times ( R 1 + R 2 ) \qquad formula 1$$

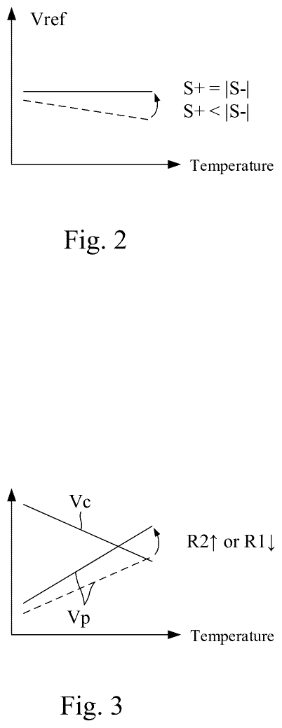

Reference is made to formula 1, Vref is the reference voltage, Vgs1 is a voltage across the first transistor M1, Vgs2 is a voltage across the second transistor M2, R1 is the first resistor, and R2 is the second resistor. Reference is made to formula 1, FIG. 2, and FIG. 3. Assuming that the reference voltage Vref in FIG. 2 is in a state that the slope S+ of the positive temperature coefficient voltage is less than the slope |S−| of the negative temperature coefficient voltage, the present disclosure can decrease the first resistor R1 or increase the second resistor R2 to enhance the slope of the positive temperature coefficient voltage Vp in FIG. 3. In this way, the reference voltage Vref in FIG. 2 can return to a state that the slope S+ of the positive temperature coefficient voltage equals the slope |S−| of the negative temperature coefficient voltage, such that the reference voltage supply circuit 100 of the present disclosure can maintain a zero temperature coefficient, thereby preventing the reference voltage Vref from being affected by temperature variation.

Reference is made to FIG. 1, in some embodiments, the first transistor M1 includes a first terminal, a control terminal, and a second terminal. The first terminal (e.g., the upper terminal) of the first transistor M1 is coupled to the high voltage level terminal Th. The second terminal (e.g., the lower terminal) of the first transistor M1 and the first terminal (e.g., the upper terminal) of the first resistor R1 are coupled at the reference node Nref. The control terminal of the first transistor M1 and the second terminal (e.g., the lower terminal) of the first resistor R1 are coupled at the first node N1.

In some embodiments, the first terminal (e.g., the upper terminal) of the second resistor R2, the control terminal of the first transistor M1, and the second terminal (e.g., the lower terminal) of the first resistor R1 are coupled at the first node N1.

In some embodiments, the second transistor M2 includes a first terminal, a control terminal, and a second terminal. The first terminal (e.g., the upper terminal) of the second transistor M2 and the second terminal (e.g., the lower terminal) of the second resistor R2 are coupled at the second node N2. The control terminal of the second transistor M2, the first terminal (e.g., the upper terminal) of the second transistor M2, and the second terminal (e.g., the lower terminal) of the second resistor R2 are coupled at the second node N2. The second terminal (e.g., the lower terminal) of the second transistor M2 is coupled to the low voltage level terminal Tl.

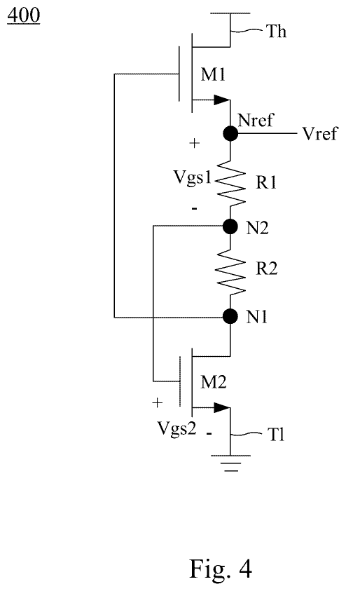

FIG. 4 shows an embodiment of a reference voltage supply circuit 400 of the present disclosure. As shown in the figure, the reference voltage supply circuit 400 includes a first transistor M1, a second transistor M2, a first resistor R1, and a second resistor R2.

With respect to circuit designs, the first transistor M1 is coupled to a high voltage level terminal Th, and the second transistor M2 is coupled to a low voltage level terminal Tl. In addition, the first resistor R1 and the first transistor M1 are coupled at a reference node Nref for providing a reference voltage Vref. The second resistor R2 is coupled between the first resistor R1 and the second transistor M2. The first resistor R1 and the second resistor R2 include variable resistors. The formula of the reference voltage Vref provided by the reference voltage supply circuit 400 of the present disclosure provide is as follows:

$$Vref = Vgs 2 + ( \frac{\vert Vgs 1 \vert}{( R 1 + R 2 )} ) \times R 1 \qquad formula 2$$

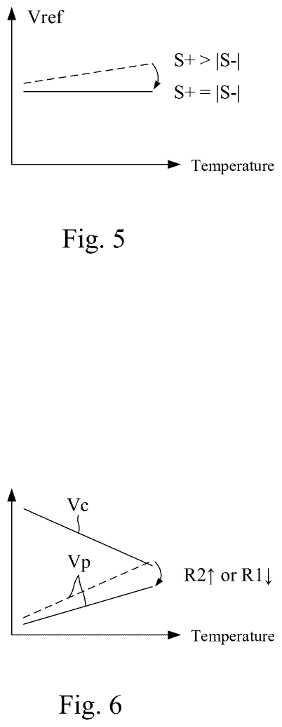

Reference is made to formula 2, Vref is the reference voltage, Vgs1 is a voltage across the first transistor M1, Vgs2 is a voltage across the second transistor M2, R1 is the first resistor, and R2 is the second resistor. Reference is made to formula 2, FIG. 5, and FIG. 6. Assuming that the reference voltage Vref in FIG. 5 is in a state that the slope S+ of the positive temperature coefficient voltage is greater than the slope |S−| of the negative temperature coefficient voltage, the present disclosure can decrease the first resistor R1 or increase the second resistor R2 to decrease the slope of the positive temperature coefficient voltage Vp in FIG. 6. In this way, the reference voltage Vref in FIG. 5 can return to a state that the slope S+ of the positive temperature coefficient voltage equals the slope |S−| of the negative temperature coefficient voltage, such that the reference voltage supply circuit 400 of the present disclosure can maintain a zero temperature coefficient, thereby preventing the reference voltage Vref from being affected by temperature variation.

Reference is made to FIG. 4, in some embodiments, the first transistor M1 includes a first terminal, a control terminal, and a second terminal. The first terminal (e.g., the upper terminal) of the first transistor M1 is coupled to the high voltage level terminal Th. The second terminal (e.g., the lower terminal) of the first transistor M1 and the first terminal (e.g., the upper terminal) of the first resistor R1 are coupled at the reference node Nref. The control terminal of the first transistor M1 and the first terminal (e.g., the lower terminal) of the second resistor R2 are coupled at the first node N1.

In some embodiments, the second terminal (e.g., the upper terminal) of the second resistor R2 and the second terminal (e.g., the lower terminal) of the first resistor R1 are coupled at the second node N2.

In some embodiments, the second transistor M2 includes a first terminal, a control terminal, and a second terminal. The first terminal (e.g., the upper terminal) of the second transistor M2, the control terminal of the first transistor M1, and the first terminal (e.g., the lower terminal) of the second resistor R2 are coupled at the first node N1. The control terminal of the second transistor M2, the second terminal (e.g., the lower terminal) of the first resistor R1, and the second terminal (e.g., the upper terminal) of the second resistor R2 are coupled at the second node N2. The second terminal (e.g., the lower terminal) of the second transistor M2 is coupled to the low voltage level terminal Tl.

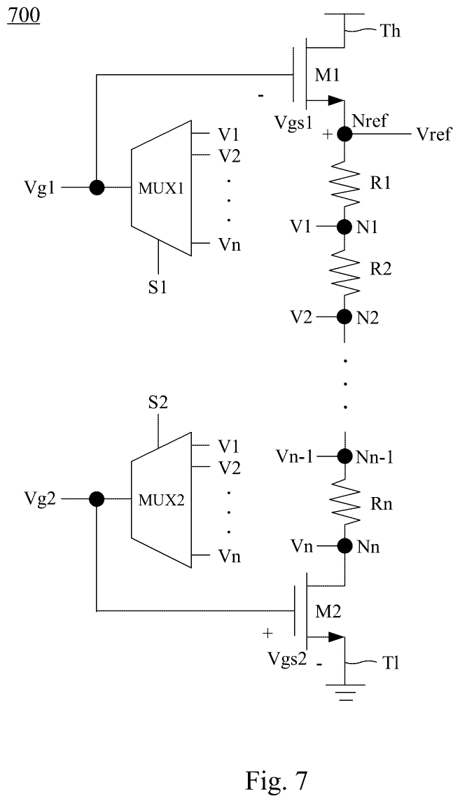

Reference is made to FIG. 7, in some embodiments, the reference voltage supply circuit 700 includes a plurality of resistors R1˜Rn. The plurality of resistors R1˜Rn are pairwise connected in series at a plurality of nodes N1˜Nn. For example, the resistor R1 and the resistor R2 are connected in series at the node N1.

In some embodiments, the first transistor M1 includes a first terminal, a control terminal, and a second terminal. The first terminal (e.g., the upper terminal) of the first transistor M1 is coupled to the high voltage level terminal Th. The second terminal (e.g., the lower terminal) of the first transistor M1 and the first terminal (e.g., the upper terminal) of the resistor R1 of the plurality of resistors R1˜Rn are coupled at the reference node Nref.

In some embodiments, the reference voltage supply circuit 700 further includes a first multiplexer MUX1. The first multiplexer MUX1 includes a first terminal and a second terminal. The first terminal (e.g., the left terminal) of the first multiplexer MUX1 is coupled to the control terminal of the first transistor M1. The second terminal (e.g., the right terminal) of the first multiplexer MUX1 is selectively coupled to one of the plurality of nodes N1˜Nn. In some embodiments, the second terminal (e.g., the right terminal) of the first multiplexer MUX1 is coupled to a target node of the plurality of nodes N1˜Nn according to a first selection signal S1. In some embodiments, the reference voltage supply circuit 700 of the present disclosure can adjust the node to which the control terminal of the first transistor M1 is connected via the first multiplexer MUX1. The formula of the voltage of the control terminal of the first transistor M1 is as follows:

$$Vg 1 = Vk 1 \qquad formula 3$$

Reference is made to formula 3, Vg1 is a voltage of the control terminal of the first transistor M1. Vk1 depends on the node to which the first multiplexer MUX1 is connected. For example, Vk1 is V1 if the first multiplexer MUX1 is connected to the node N1, Vk1 is V2 if the first multiplexer MUX1 is connected to the node N2, and so on. k1 is between 1 and N.

In some embodiments, the first terminal (e.g., the upper terminal) of the resistor Rn of the plurality of resistors R1˜Rn is coupled to one of the plurality of resistors R1˜Rn.

In some embodiments, the second transistor M2 includes a first terminal, a control terminal, and a second terminal. The first terminal (e.g., the upper terminal) of the second transistor M2 and the second terminal (e.g., the lower terminal) of the resistor Rn are coupled at one of the plurality of nodes (e.g., node Nn). The second terminal (e.g., the lower terminal) of the second transistor M2 is coupled to the low voltage level terminal Tl.

In some embodiments, the reference voltage supply circuit 700 further includes a second multiplexer MUX2. The second multiplexer MUX2 includes a first terminal and a second terminal. The first terminal (e.g., the left terminal) of the second multiplexer MUX2 is coupled to the control terminal of the second transistor M2. The second terminal (e.g., the right terminal) of the second multiplexer MUX2 is selectively coupled to one of the plurality of nodes N1˜Nn. In some embodiments, the second terminal (e.g., the right terminal) of the second multiplexer MUX2 is coupled to a target node of the plurality of nodes N1˜Nn according to a second selection signal S2. In some embodiments, the plurality of resistors R1˜Rn can be selectively coupled to the control terminals of the first transistor M1 and the second transistor M2 via the plurality of nodes N1˜Nn thereby forming different resistor values. In some embodiments, each resistor value of the plurality of resistors R1˜Rn can be the same, or each resistor value can be different. In some embodiments, the reference voltage supply circuit 700 of the present disclosure can adjust the node to which the control terminal of the second transistor M2 is connected via the second multiplexer MUX2. The formula of the voltage of the control terminal of the second transistor M2 is as follows:

$$Vg 2 = Vk 2 \qquad formula 4$$

Reference is made to formula 4, Vg2 is a voltage of the control terminal of the second transistor M2. Vk2 depends on the node to which the second multiplexer MUX2 is connected. For example, Vk2 is V1 if the second multiplexer MUX2 is connected to the node N1, and Vk2 is V2 if the second multiplexer MUX2 is connected to the node N2, and so on. k2 is between 1 and N.

The formula of the reference voltage Vref provided by the reference voltage supply circuit 700 of the present disclosure is as follows:

$$Vref = Vgs 2 + ( \frac{\vert Vgs 1 \vert}{k 1 \times R} ) \times ( k 2 \times R ) \qquad formula 5$$

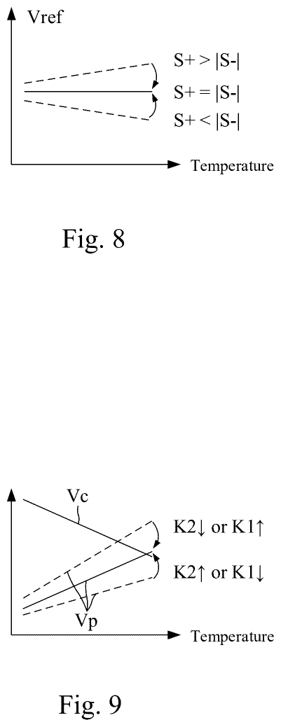

Reference is made to formula 5, Vref is the reference voltage, Vgs1 is a voltage across the first transistor M1, and Vgs2 is a voltage across the second transistor M2. k1 and k2 depend on the nodes to which the first multiplexer MUX1 and the second multiplexer MUX2 are connected. Reference is made to formula 5, FIG. 8, and FIG. 9, assuming that the reference voltage Vref in FIG. 8 is in a state that the slope S+ of the positive temperature coefficient voltage is greater than the slope |S−| of the negative temperature coefficient voltage, the present disclosure can reduce the ratio of k2/k1 to decrease the slope of the positive temperature coefficient voltage Vp in FIG. 9. In this way, the reference voltage Vref in FIG. 8 can return to a state that the slope S+ of the positive temperature coefficient voltage equals the slope |S−| of the negative temperature coefficient voltage, such that the reference voltage supply circuit 700 of the present disclosure maintains a zero temperature coefficient, thereby preventing the reference voltage Vref from being affected by temperature variation.

In addition, assuming that the reference voltage Vref in FIG. 8 is in a state that the slope S+ of the positive temperature coefficient voltage is less than the slope |S−| of the negative temperature coefficient voltage, the present disclosure can increase the ratio of k2/k1 to raise the slope of the positive temperature coefficient voltage Vp in FIG. 9. In this way, the reference voltage Vref in FIG. 8 can return to a state that the slope S+ of the positive temperature coefficient voltage equals the slope |S−| of the negative temperature coefficient voltage, such that the reference voltage supply circuit 700 of the present disclosure maintains a zero temperature coefficient, thereby preventing the reference voltage Vref from being affected by temperature variation.

In some embodiments, reference is made to FIG. 1, FIG. 4, and FIG. 7. The first transistor M1 and the second transistor M2 can be Metal-Oxide-Semiconductor Field-Effect Transistors (MOSFETs). In some embodiments, the first transistor M1 and the second transistor M2 can be N-type MOSFETs or P-type MOSFETs. In some embodiments, the first terminal can be a drain, the control terminal can be a gate, and the second terminal can be a source.

It is noted that the present disclosure is not limited to the embodiments as shown in FIG. 1 to FIG. 9, they are merely examples for illustrating the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The reference voltage supply circuit of the present disclosure adopts variable resistors to adjust the slope of the temperature coefficient voltage with respect to temperature variation, such that the reference voltage supply circuit of the present disclosure can maintain a zero temperature coefficient to prevent the reference voltage from being affected by temperature variation.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A reference voltage supply circuit, comprising:
a first transistor, coupled to a high voltage level terminal;
a second transistor, coupled to a low voltage level terminal;
a first resistor, coupled with the first transistor at a reference node for providing a reference voltage; and
a second resistor, coupled between the first resistor and the second transistor, wherein the first resistor and the second resistor comprise variable resistors.

2. The reference voltage supply circuit of claim 1, wherein the first transistor comprises:
a first terminal, coupled to the high voltage level terminal;
a second terminal, coupled with a first terminal of the first resistor at the reference node; and
a control terminal, coupled with a second terminal of the first resistor at a first node.

3. The reference voltage supply circuit of claim 2, wherein a first terminal of the second resistor, the control terminal of the first transistor, and the second terminal of the first resistor are coupled at the first node.

4. The reference voltage supply circuit of claim 3, wherein the second transistor comprises:
a first terminal, coupled with a second terminal of the second resistor at a second node;
a control terminal, coupled with the first terminal of the second transistor and the second terminal of the second resistor at the second node; and
a second terminal, coupled to the low voltage level terminal.

5. The reference voltage supply circuit of claim 4, wherein a first resistor value of the first resistor is decreased, or a second resistor value of the second resistor is increased so as to increase a slope of a positive temperature coefficient voltage with respect to a temperature variation.

6. The reference voltage supply circuit of claim 1, wherein the first transistor comprises:
a first terminal, coupled to the high voltage level terminal;
a second terminal, coupled with a first terminal of the first resistor at the reference node; and
a control terminal, coupled with a first terminal of the second resistor at a first node.

7. The reference voltage supply circuit of claim 6, wherein a second terminal of the second resistor and a second terminal of the first resistor are coupled at a second node.

8. The reference voltage supply circuit of claim 7, wherein the second transistor comprises:
a first terminal, coupled with the control terminal of the first transistor and the first terminal of the second resistor at the first node;
a control terminal, coupled with the second terminal of the first resistor and the second terminal of the second resistor at the second node; and
a second terminal, coupled to the low voltage level terminal.

9. The reference voltage supply circuit of claim 8, wherein a first resistor value of the first resistor is decreased, or a second resistor value of the second resistor is increased so as to decrease a slope of a positive temperature coefficient voltage with respect to a temperature variation.

10. The reference voltage supply circuit of claim 1, further comprising:
a plurality of resistors, pairwise connected in series at a plurality of nodes, wherein the plurality of resistors comprise the first resistor and the second resistor.

11. The reference voltage supply circuit of claim 10, wherein the first transistor comprises:
a first terminal, coupled to the high voltage level terminal;
a second terminal, coupled with a first terminal of the first resistor of the plurality of resistors at the reference node; and
a control terminal.

12. The reference voltage supply circuit of claim 11, further comprising:
a first multiplexer, comprising:
a first terminal, coupled to the control terminal of the first transistor; and
a second terminal, selectively coupled to one of the plurality of nodes.

13. The reference voltage supply circuit of claim 12, wherein the second terminal of the first multiplexer is coupled to a first target node of the plurality of nodes according to a first selection signal.

14. The reference voltage supply circuit of claim 13, wherein a first terminal of the second resistor of the plurality of resistors is coupled to one of the plurality of resistors.

15. The reference voltage supply circuit of claim 14, wherein the second transistor comprises:
a first terminal, coupled to a second terminal of the second resistor at one of the plurality of nodes;
a control terminal; and
a second terminal, coupled to the low voltage level terminal.

16. The reference voltage supply circuit of claim 15, further comprising:
a second multiplexer, comprising:
a first terminal, coupled to the control terminal of the second transistor; and
a second terminal, selectively coupled to one of the plurality of nodes.

17. The reference voltage supply circuit of claim 16, wherein the second terminal of the second multiplexer is coupled to a second target node of the plurality of nodes according to a second selection signal.

18. The reference voltage supply circuit of claim 1, wherein the first transistor and the second transistor comprise transistors of a same type.

19. The reference voltage supply circuit of claim 1, wherein the high voltage level terminal comprises a power supply voltage terminal.

20. The reference voltage supply circuit of claim 1, wherein the low voltage level terminal comprises a ground terminal.
